(19) United States
(12) Patent Application Publication
(10) Pub. No.: US 2003/0049498 A1
(43) Pub. Date: Mar. 13, 2003

(54) Perpendicular magnetic recording medium and method of manufacturing the same

(76) Inventor: Manabu Shimosato, Nagano (JP)

Correspondence Address: ROSSI & ASSOCIATES, P.O. Box 826, Ashburn, VA, 20146-0826, US

(21) Appl. No.: 10/209,675

(22) Filed: Jul. 31, 2002

(30) Foreign Application Priority Data
Jul. 31, 2001 (JP) JP 2001-232786

(51) Int. Cl. G11B 5/72

(52) U.S. Cl. 428/694 TS; 428/694 BP; 428/695

(57) ABSTRACT

A perpendicular magnetic recording medium and method with reduced media noise has an under-layer, an intermediate layer with an amorphous structure, a recording layer, a protective layer, and a liquid lubricant layer sequentially laminated on a substrate. By providing an amorphous intermediate layer, the recording layer, which is formed on the intermediate layer, is made to have a fine grain size and a uniform grain size distribution.

### BACKGROUND

A rapid increase in information quantity in communications is pushing for magnetic recording media with a higher recording density. Enhancement of recording density as high as 100% per year is demanded in recent years. Conventional planar magnetic recording will limit the enhancement of recording density in the near future. To overcome this limit, a perpendicular magnetic recording medium has been proposed where magnetization is formed in the direction perpendicular to the substrate plane.

2 Higher the recording density, however, higher the media noise, which increases in proportion to the linear recording density. Media noise is large in a conventional perpendicular magnetic recording media, causing a serious problem. Methods of reducing media noise in a perpendicular magnetic recording medium have been proposed, including the use of amorphous carbon in an intermediate layer as disclosed in Japanese Unexamined Patent Application Publication No. H6-176340, and the use of metals or alloys of Zr, Ru, Ti, or CoCr in an intermediate layer or in an under-layer as disclosed in Japanese Unexamined Patent Application Publication Nos. H10-11735 and 2001-93139. All these methods reduce media noise by improving alignment of crystal structure of a magnetic layer formed on the intermediate layer. There still remains a need for alternative methods of reducing media noise. The present invention addresses this need.

### SUMMARY OF THE INVENTION

The present invention relates to a magnetic recording medium, such as used in a hard disk or other equipment, in particular, to a perpendicular magnetic recording medium and a method of manufacturing such a magnetic recording medium.

One aspect of the present invention is a perpendicular magnetic recording medium having a substrate and an under-layer, an intermediate layer having an amorphous structure, a recording layer, a protective layer, and a liquid lubricant layer sequentially laminated on the substrate. The recording layer formed on the intermediate layer has a fine grain size and a uniform grain size distribution by providing the intermediate layer with the amorphous structure.

Another aspect of the present invention is a method of manufacturing the perpendicular magnetic recording medium comprising the steps of sequentially laminating the under-layer, the intermediate layer, the recording layer, the protective layer, and the liquid lubricant layer on the substrate. Because the intermediate layer has an amorphous structure, the recording layer formed on the intermediate layer has a fine grain size and a uniform grain size distribution.

The composition of the intermediate layer can be of Ti₁₀₀₋ₐXₐ, where X can be chromium (Cr) or ruthenium (Ru) and a can be 0≦a<100 in atomic percent, or can be of Zr_{100-b}Y_{b}, where Y can be Cr or Ru and b can be 0≦b<100 in atomic percent. More specifically, a can be0<a≦50, and X can be Cr, and b can be 0<b≦75, and Y can be Ru.

The thickness of the intermediate layer can be in the range from 1 nm to 20 nm.

### BRIEF DESCRIPTION OF THE DRAWINGS

8 FIG. 1 is a schematic cross-sectional view of a perpendicular magnetic recording medium according to the present invention.

FIG. 2 is a transmission electron micrograph of a perpendicular magnetic recording medium of Example 1 according to the present invention.

FIG. 3 is a transmission electron micrograph of a perpendicular magnetic recording medium of Example 2 according to the present invention.

FIG. 4 is a transmission electron micrograph of a perpendicular magnetic recording medium of Example 3 according to the present invention.

FIG. 5 is a transmission electron micrograph of a perpendicular magnetic recording medium of Example 4 according to the present invention.

FIG. 6 is a transmission electron micrograph of a perpendicular magnetic recording medium of Comparative Example 1.

FIG. 7 is a transmission electron micrograph of a perpendicular magnetic recording medium of Comparative Example 2.

FIG. 8 is a transmission electron micrograph of a perpendicular magnetic recording medium of Comparative Example 3.

### DETAILED DESCRIPTION

The present invention will be described referring to FIG. 1. FIG. 1, however, is a mere exemplary embodiment. Accordingly, the present invention is not to be limited to this embodiment. A perpendicular magnetic recording medium of the present invention has a magnetic layer with a fine grain size and a small variance in the grain size by using an intermediate layer 13. The intermediate layer 13 in the medium has an amorphous structure that makes the grain size of the recording material formed on the intermediate layer 13 and the variance of the grain size small. The distribution of the grain size is made uniform by forming the intermediate layer 13 with the amorphous structure.

The perpendicular magnetic recording medium has an under-layer 12, an intermediate layer 13, a recording layer 14, a protective layer 15, and a liquid lubricant layer 16 sequentially laminated on a substrate 1. The intermediate layer 13 has an amorphous structure. The grain size of the recording layer material on the intermediate layer 13 is made fine and distribution of the grain size is made uniform by forming the intermediate layer 13 with an amorphous structure. The intermediate layer 13 can be an alloy, including titanium or zirconium. Specifically, the composition of the intermediate layer can be Ti₁₀₀₋ₐXₐ, where X is Cr or Ru, and “a” is 0≦a<100 in atomic percent, or Zr_{100-b}Y_{b}, where Y is Cr or Ru, and “b” is 0≦b<100 in atomic percent. More specifically, “a”and “b” can be 0<a≦50 and 0<b≦75, respectively. More specifically, X can be Cr and Y can be Ru. The thickness of the intermediate layer can be in the range from 1 nm to 20 nm.

The method of the present invention for manufacturing a perpendicular magnetic recording medium comprises the steps of sequentially laminating at least the under-layer 12, the intermediate layer 13, the recording layer 14, the protective layer 15, and the liquid lubricant layer 15 on the substrate 11.

Known methods of reducing media noise in a perpendicular magnetic recording medium include a method to reduce magnetization of crystal grains in the recording layer, a method to reduce magnetic interaction between crystal grains in the recording layer, and a method to improve alignment of crystal grains in the recording layer. Media noise in the perpendicular magnetic recording media, however, is reduced according to the present invention by reducing the grain size and the variance of the grain size of the recording layer.

The material that can be used in the substrate 11 in the present invention includes a NiP-plated aluminum alloy, strengthened glass, and crystallized glass, which are all used in a conventional magnetic recording medium.

The material for the under-layer 12 can be selected from an amorphous cobalt alloy, a NiFe alloy, a sendust alloy (i.e., an FeSiAl alloy), and an FeTaC alloy. In the present invention, in particular, the NiFe alloy is preferable. Examples of amorphous cobalt alloys include CoNbZr and CoTaZr. The thickness of the under-layer 12 can be in the range from 5 nm to 200 nm, the optimum value depending on the structure and characteristics of the magnetic head used for recording.

In the present invention, Ti, Zr, or an alloy containing these metals can be used in the intermediate layer 13. Specifically, the composition of the intermediate layer 13 in the present invention can be Ti₁₀₀₋ₐXₐ, where X is Cr or Ru, and “a” is 0≦a<100 in atomic percent, or Zr_{100-b}Y_{b}, where Y is Cr or Ru, and “b” is 0≦b<100 in atomic percent. More specifically, “a” and “b” can be 0<a≦50 and 0<b≦75, respectively. More specifically, X can be Cr and Y can be Ru, with the alloys of Ti75-Cr25 and Zr50-Ru50 being most preferable.

The material of the intermediate layer 13 needs to be amorphous or has to have an amorphous structure. By making the intermediate layer 13 amorphous and forming the recording layer 14 according to the manufacturing method for a perpendicular magnetic recording medium as described later, the grain size of the recording layer is decreased and the variance of the grain size is minimized, leading to reduction in media noise.

The thickness of the intermediate layer 13 can be from 1 to 20 nm thick. The thickness in this range has the effect to reduce media noise. The thickness in the range from 1 to 10 nm is more effective in reducing media noise in all the materials mentioned above, with the range from 5 to 10 nm being most preferable.

The recording layer 14 of the invention can be a magnetic layer made of a crystalline alloy of CoCr system. Preferable material for the crystalline alloy film of CoCr system in a perpendicular magnetic recording medium of the present invention includes CoCr, CoCrTa, CoCrPt, and CoCrPrX, wherein X is B, Ta, Zr, or Nb. The thickness of the crystalline alloy film of CoCr system of the recording layer 14 is preferably in the range from 5 nm to 50 nm. The grain size of the recording layer 14 is preferably from 5 to 7 nm and the standard deviation, which is a square root of the variance, of the grain size is preferably from 1.5 to 2.5 nm.

The protective layer 15 can be laminated by using a conventional material, for example, a material composed mainly of carbon. The thickness and other conditions in the protective layer 15 can be adjusted in the same conditions as in a conventional magnetic recording medium. For example, the thickness can be adjusted in the range from 2 to 10 nm.

The liquid lubricant layer 16 can also be formed using a conventional material, such as a perfluoropolyether lubricant. The thickness and other conditions in the liquid lubricant layer 16 also can be adjusted in the same conditions as in a conventional magnetic recording medium. For example, the thickness can be preferably adjusted in the range from 1 to 2 nm.

Next, the method of the present invention for manufacturing the perpendicular magnetic recording medium will be described below.

The present method comprises the steps of laminating the under-layer 12, laminating the intermediate layer 13, laminating the recording layer 14, laminating the protective layer 15, and laminating the liquid lubricant layer 16 sequentially on the substrate 11. The intermediate layer 13 in the invention is made to have an amorphous structure. By forming the recording layer 14 on the intermediate layer 13 that is in an amorphous state, the average grain size of the magnetic recording material is minimized and the variance of the grain size is made small, which means uniform distribution of the grain size variance.

The first step laminates the under-layer 12 on the substrate 11. The substrate 11 used in this step may be selected from a NiP-plated aluminum alloy, strengthened glass, and crystallized glass, which are used in a conventional magnetic recording medium. Because several layers are laminated on the substrate 11, the substrate should be flat and clean. On this substrate 11, the under-layer 12 is laminated by means of sputtering or plating. The under-layer 12 can be laminated using an amorphous Co alloy, a NiFe alloy, a sendust alloy (, i.e., an FeSiAl alloy), or an FeTaC alloy. The NiFe alloy is preferable in the present invention. An amorphous cobalt alloy, for example CoNbZr or CoTaZr, also can be used. The thickness of the under-layer 12 is preferably in the range from 5 nm to 200 nm, the optimum value depending on the structure and characteristics of a magnetic head used for recording.

The second step laminates the intermediate layer 13. The intermediate layer 13 may be formed by means of sputtering. The intermediate layer 13 is used for performing the function of magnetically isolating the recording layer 14 from the under-layer 12, and controlling characteristics of the crystalline alloy film of CoCr system of the recording layer 14. Specifically, the intermediate layer 13 in the present invention is used for minimizing the grain size and reducing the variance of the grain size in the crystalline film of the recording layer 14. This requires the intermediate layer 13 to have an amorphous structure.

To make the intermediate layer 13 amorphous, the layer 13 is laminated by means of sputtering at a temperature between the room temperature and 250° C., more preferably, between the room temperature and 150° C. under a pressure between 0.1 and 100 mTorr, more preferably between 1 and 20 mTorr. Preferable material for the intermediate layer 13 includes metals of Ti and Zr, and an alloy containing Ti or Zr, as described previously.

The third step laminates the recording layer 14. This layer is formed by means of sputtering using a crystalline alloy of CoCr system as a target. The crystalline alloy of CoCr system includes, for example, CoCr, CoCrTa, CoCrPt, and CoCrPtX, wherein X is B, Ta, Zr, or Nb. The sputtering method in the present invention can use a target that allows forming a crystalline film with a desired composition. The thickness of the crystalline alloy film of CoCr system is preferably in the range from 5 nm to 50 nm. The sputtering is conducted using, for example, argon gas, which is commonly used in sputtering, and sputtering conditions may be adjusted by controlling argon gas flow rate or controlling opening of the valve connecting to a vacuum pump. The argon gas pressure may be controlled in the range from 0.1 mTorr to 100 mTorr, preferably from 1 to 20 mTorr.

By making the intermediate layer 13 to have an amorphous structure in the manufacturing process of a perpendicular magnetic recording medium in the present invention, the grain size of the recording layer 14 is minimized and the variance of the grain size is decreased in the process of laminating the recording layer 14. This leads to reduction in media noise.

The next step laminates the protective layer 15. Methods for laminating the protective layer 15 include sputtering method, CVD method, and cathodic arc carbon method. The protective layer 15 is laminated on the recording layer 14 by means of one of these methods. The protective layer 14 can be formed using a conventional material. A material mainly composed of carbon, for example, can be used for forming the layer 14. The thickness and other conditions in the protective layer 15 can be adjusted in the same conditions as in a conventional magnetic recording medium. For example, the thickness can be adjusted in the range from 2 to 10 nm.

When each step described above in the invention is conducted by sputtering, the deposition may be performed under gas pressure of 0.1 mTorr to 100 mTorr, as mentioned above. The more preferable gas pressure is in the range from 1 to 20 mTorr. The sputtering is conducted using argon gas, which is commonly used in sputtering, and the argon gas pressure is adjusted by controlling argon gas flow rate or controlling opening of the valve connecting to a vacuum pump. Other conditions may be appropriately selected corresponding to the deposition condition of each layer. The temperature, for example, can be adjusted between the room temperature and 500° C.

The sputtering method may be mainly used in the manufacturing method of the invention. The sputtering method is advantageous because it allows continuous processing in a series of steps in one vacuum chamber. However, other methods also can be applied in the present invention, as long as the intermediate layer 13 is made amorphous, and the fine grain size and the small variance of the grain size of the recording layer 14 are achieved.

The magnetic recording medium with thus laminated layers is taken out from the vacuum chamber, and finally, a liquid lubricant layer 16 is laminated. The liquid lubricant layer 16 can be formed using a conventional material, such as a perfluoropolyether lubricant. The liquid lubricant layer 16 can be laminated by coating the magnetic recording medium processed in the above-described steps with a solution of the lubricant dissolved in a proper solvent by means of a dip-coating method, a spray method, or a spin-coating method. The thickness and other conditions in the liquid lubricant layer 16 can be adjusted in the same conditions as in a conventional magnetic recording medium. For example, the thickness can be adjusted in the range from 1 to 2 nm.

The examples of the present invention will be further described below referring to Examples 1-4. These Examples are only for explaining the invention, not for restricting the scope of the invention.

The substrate used was a commercially available glass substrate having an outer diameter of 95 mm and a thickness of 1.0 mm. The substrate was cleaned and introduced into a vacuum chamber of a sputtering apparatus. Laminated to the substrate are, an under-layer of a NiFe alloy with a thickness of 20 nm, and an intermediate layer with a thickness of 5 nm, as described in Examples and Comparative Examples below, and a recording layer of Co—Cr20-Pt12-B2 with a thickness of 28 nm. The temperature and pressure in the sputtering process were 250° C. and 5 mTorr. After laminating a carbon protective layer having a thickness of 7 nm by sputtering, the resulting substrate was taken out from the vacuum chamber. Finally, a liquid lubricant layer of perfluoropolyether with a thickness of 2 nm was formed by dip-coating. Thus, a perpendicular magnetic recording medium was manufactured.

### EXAMPLE 1

A perpendicular magnetic recording medium was prepared according to the above-described manufacturing method with an intermediate layer formed by using Zr50-Ru50.

### EXAMPLE 2

A perpendicular magnetic recording medium was prepared according to the above-described manufacturing method with an intermediate layer formed by using Zr.

### EXAMPLE 3

A perpendicular magnetic recording medium was prepared according to the above-described manufacturing method with an intermediate layer formed by using Ti75-Cr25.

### EXAMPLE 4

A perpendicular magnetic recording medium was prepared according to the above-described manufacturing method with an intermediate layer formed by using Ti.

### Comparative Example 1

A perpendicular magnetic recording medium was prepared according to the above-described manufacturing method with an intermediate layer formed by using Ru.

### Comparative Example 2

A perpendicular magnetic recording medium was prepared according to the above-described manufacturing method with an intermediate layer formed by using Co55-Cr45.

### Comparative Example 3

A perpendicular magnetic recording medium was prepared according to the above-described manufacturing method with an intermediate layer formed by using Co50-Cr25-Ru25.

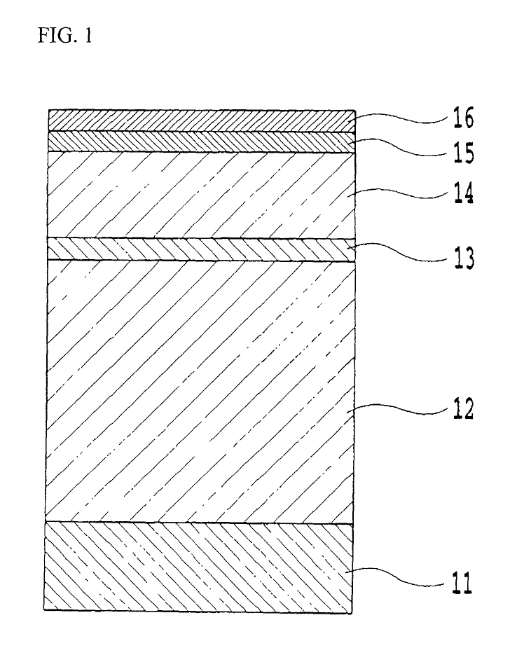

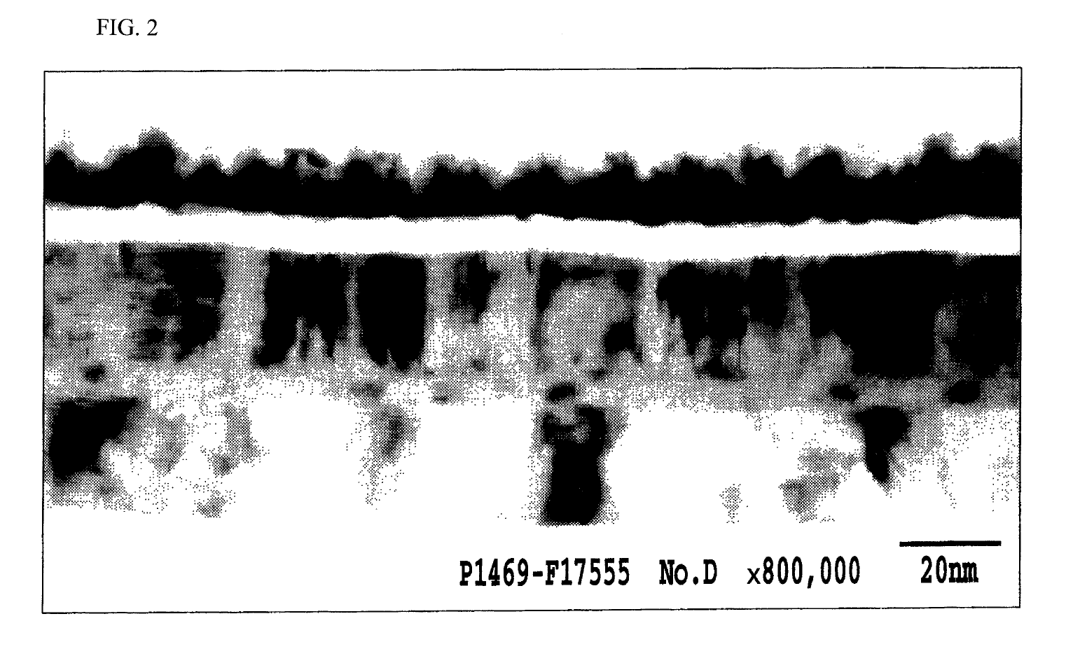

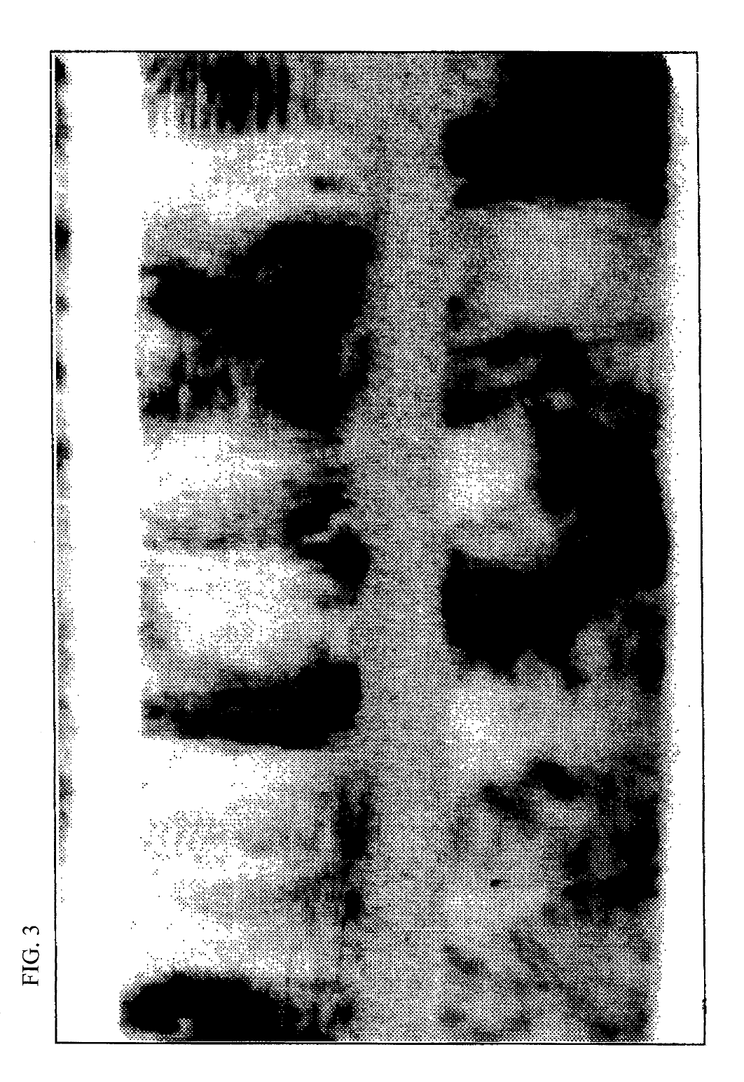

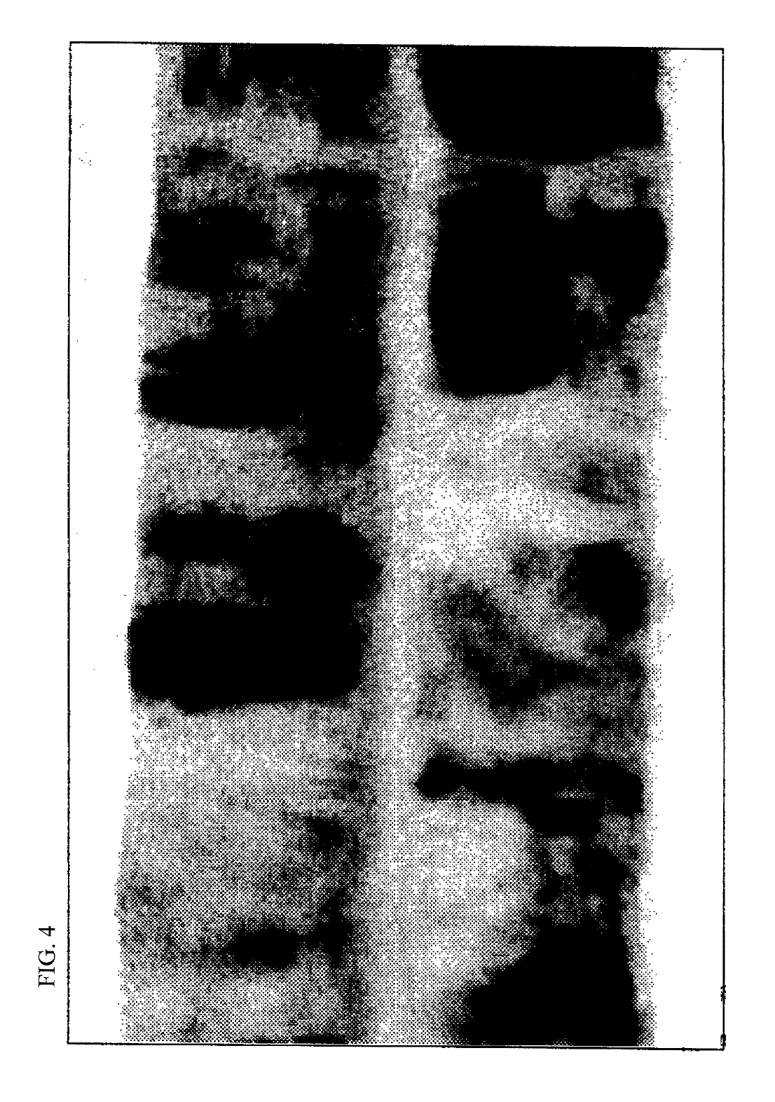

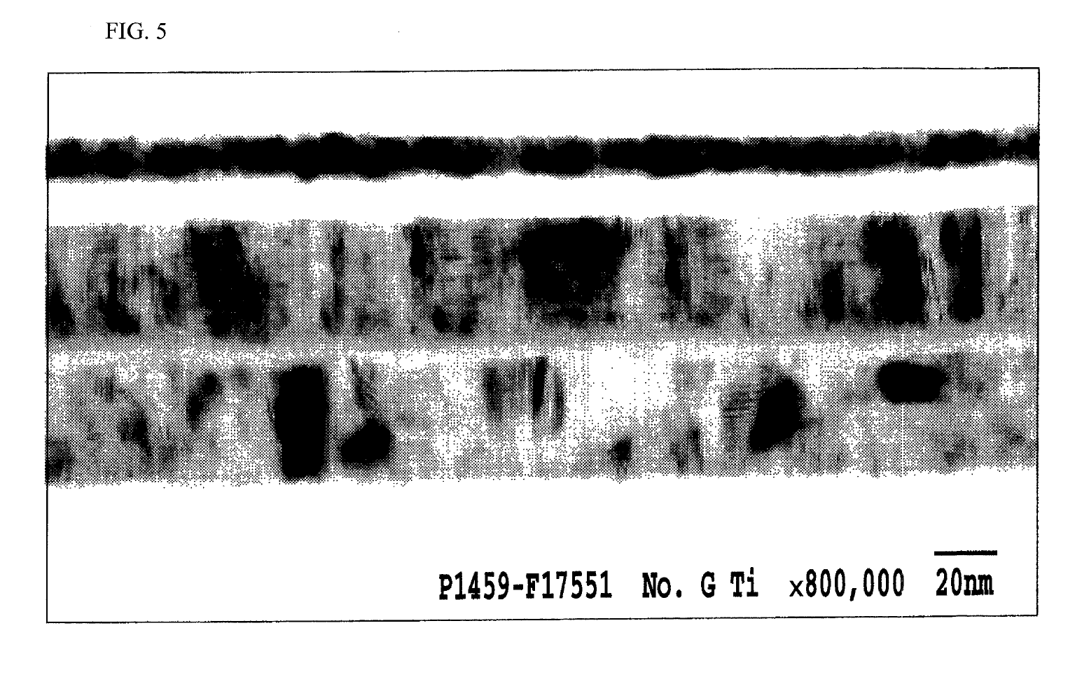

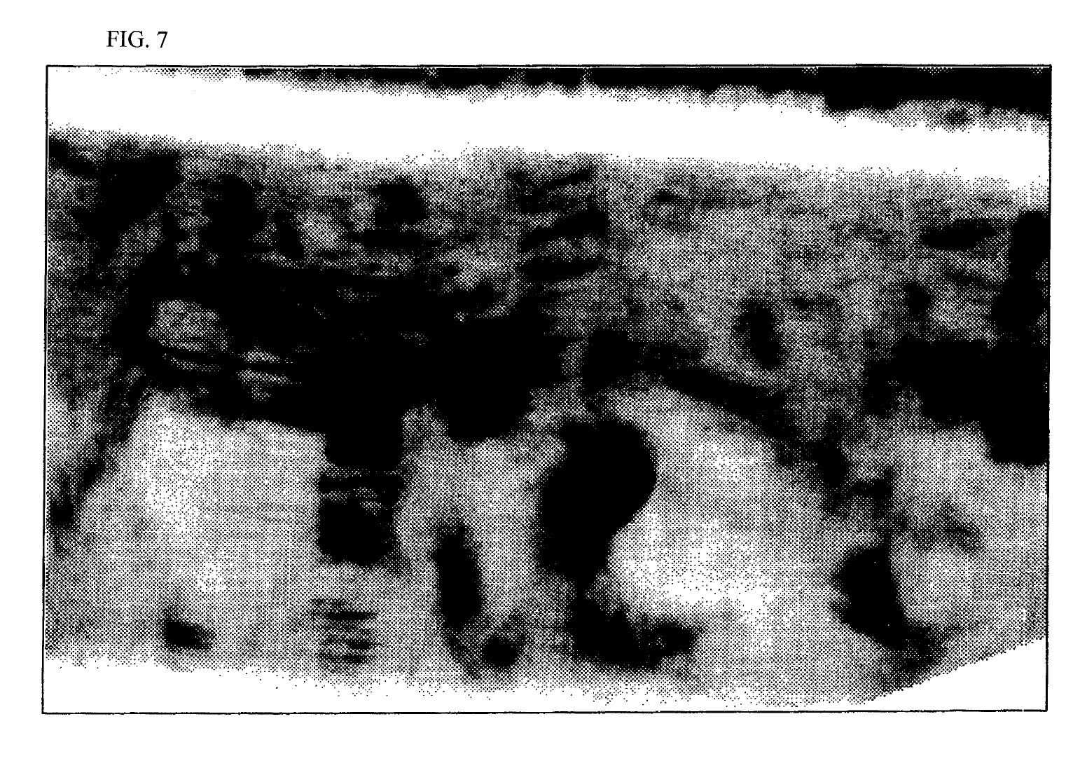

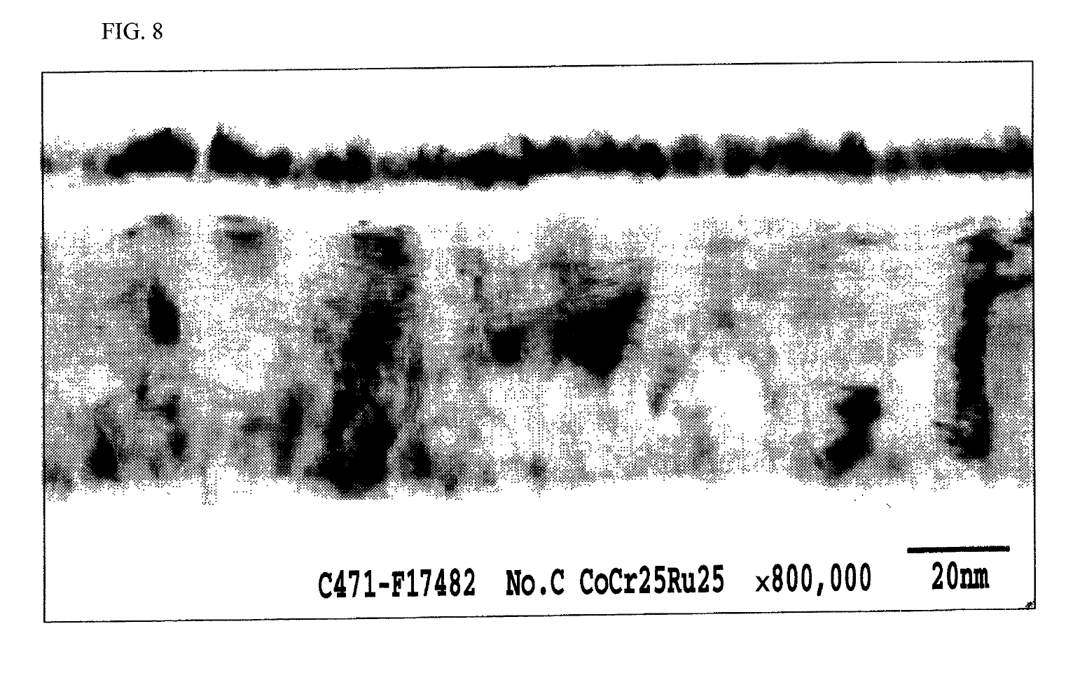

FIGS. 2-8 illustrate photographs of the cross-sections of the obtained perpendicular magnetic recording medium taken by a transmission electron microscope (TEM). The structures of the intermediate layers were observed. The grain size distribution was measured by processing a dark field picture on the TEM. The film thickness was measured using a contact profile meter. The electromagnetic transformation characteristic was measured using a commercially available spinning stand equipped with a head for a hard disk and a circuit for electromagnetic transformation measurement.

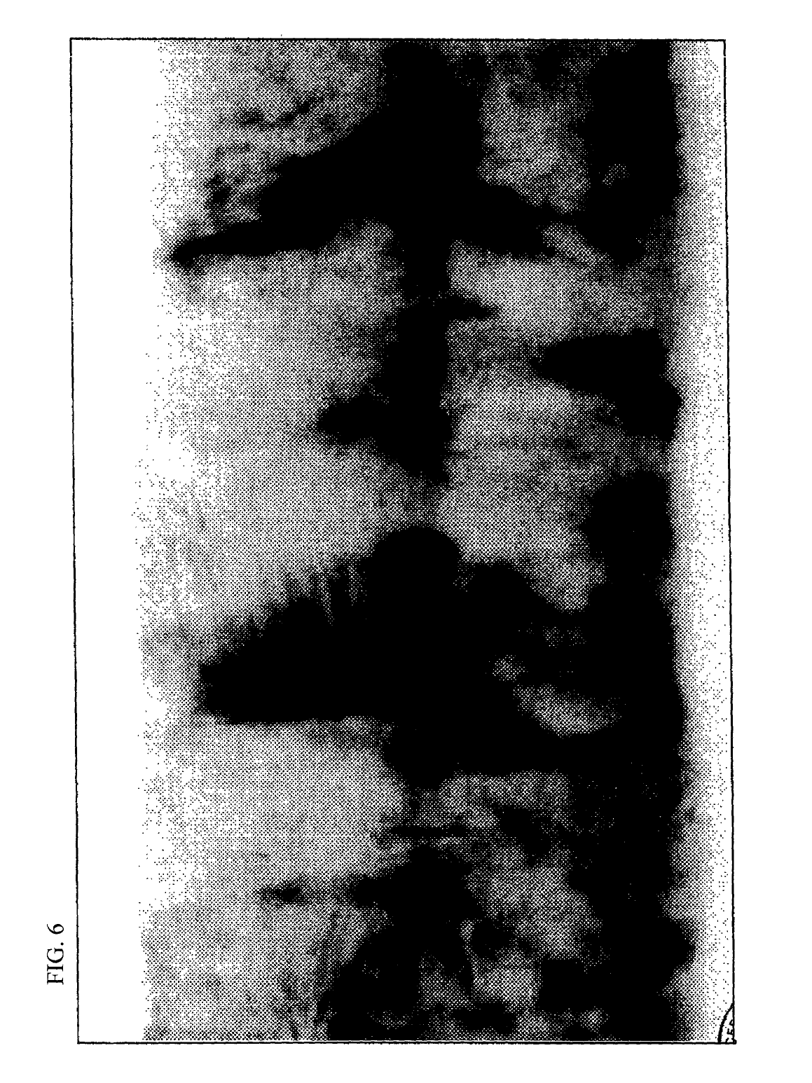

All of Examples 1 through 4 showed an amorphous structure, as illustrated in FIGS. 2-5. This is known from the fact that a layer of homogeneous structure without a crystalline structure was observed at the intermediate layer portion of the picture. All of Comparative Examples 1 through 3, in contrast, showed a crystalline structure, as illustrated in FIGS. 6-8. The differences in crystal structure cannot be found between the under-layer and the recording layer, except the contrast in brightness corresponding to the atomic number.

Table 1 summarizes the measured results of the grain size of the recording layer obtained by the TEM for the recording media having the intermediate layer indicated in the Examples and Comparative Examples. It is apparent that the average grain size and the standard deviation of the grain size have been significantly reduced in the Examples 1 through 4 as compared with the Comparative Examples 1 through 3. The normalized variance in Table 1 is defined by the following equation:

Normalized deviation=standard deviation (nm)/average grain size (nm)×100 (%)

TABLE 1
(MEASURED GRAIN SIZE OF THE RECORDING LAYER)

| | Example | Example | Example | Example | Comp | Comp | Comp |
|---|---|---|---|---|---|---|---|
| | 1 | 2 | 3 | 4 | Ex 1 | Ex 2 | Ex 3 |
| Material | Zr50- | Zr | Ti75- | Ti | Ru | Co55- | Co50- |
| | Ru50 | | Cr25 | | | Cr45 | Cr25 |
| Average | 6.3 | 5.8 | 5.9 | 6.7 | 11.5 | 11.2 | 8.3 |
| grain size | | | | | | | |
| (nm) | | | | | | | |
| Standard | 1.83 | 1.58 | 1.56 | 2.28 | 3.94 | 3.60 | 2.52 |
| Deviation | | | | | | | |
| (nm) | | | | | | | |
| Normalized | 29.2 | 27.1 | 26.6 | 34.1 | 34.3 | 32.1 | 30.3 |
| Deviation | | | | | | | |
| (%) | | | | | | | |

The media signal-to-noise ratio for each sample of the Examples 1 through 4 and the Comparative Examples 1 through 3 was measured using a commercially available GMR head for areal recording density of 15 Gbits/in² at the rotating speed of 4,500 rpm, at the radial position of 30 mm, and in the skew angle of zero degree. The head flying height was about 25 nm. A comparison was made at the linear recording density of 160 kfci. The output used for the signal-to-noise ratio calculation was an average output obtained from one whole track. The noise used for the calculation was a square root of the integration over the frequency band of 1 to 200 MHz of the value that was obtained by subtracting the output signal and the circuit noise at each frequency from the output spectrum value at the normal linear recording density. The results are shown in Table 2. This table demonstrates the improvement by 3 to 4 dB in the Examples 1-4 compared with Comparative Examples 1-3. There is no significant difference in the signal-to-noise ratio among the Examples 1-4 (and also among the Comparative Examples 1-3). Consequently, the improvement by 3 to 4 dB can be attributed to the effect of reducing the average grain size and the variance of the grain size by employing the amorphous intermediate layer, as explained earlier.

TABLE 2
(SIGNAL-TO-NOISE RATIO, AN ELECTROMAGNETIC TRANSFORMATION
CHARACTERISTIC MEASURED AT A LINEAR RECORDING DENSITY OF
160 kfci)

| | Example | Example | Example | Example | Comp | Comp | Comp |
|---|---|---|---|---|---|---|---|
| | 1 | 2 | 3 | 4 | Ex 1 | Ex 2 | Ex 3 |
| Material | Zr50- | Zr | Ti75- | Ti | Ru | Co55- | Co50- |
| | Ru50 | | Cr25 | | | Cr45 | Cr25 |
| S/N (dB) | 16.0 | 16.1 | 16.7 | 17.4 | 13.4 | 13.1 | 13.2 |

Media noise has been reduced in the present invention by forming an intermediate layer having an amorphous structure over a substrate by means of sputtering, for example. This provides a magnetic recording medium with a high recording density. The intermediate layer of the present invention preferably uses titanium, zirconium, or an alloy containing titanium or zirconium.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP PA 2001-232786, in its entirety, including the drawings, claims, and the specification thereof, is incorporated herein by reference.

I claim:

1. A perpendicular magnetic recording medium comprising:
a substrate; and
an under-layer, an intermediate layer having an amorphous structure, a recording layer, a protective layer, and a liquid lubricant layer sequentially laminated on the substrate,
wherein the recording layer formed on the intermediate layer has a fine grain size and a uniform grain size distribution by providing the intermediate layer with the amorphous structure.

2. A perpendicular magnetic recording medium according to claim 1, wherein the intermediate layer has a composition of Ti₁₀₀₋ₐXₐ, where X is chromium (Cr) or ruthenium (Ru) and a is 0≦a<100 in atomic percent.

3. A perpendicular magnetic recording medium according to claim 2, wherein a is 0<a≦50.

4. A perpendicular magnetic recording medium according to claim 2, wherein X is Cr.

5. A perpendicular magnetic recording medium according to claim 1, wherein the intermediate layer has a composition of Zr_{100-b}Y_{b}, where Y is Cr or Ru and b is 0≦b<100 in atomic percent.

6. A perpendicular magnetic recording medium according to claim 5, wherein b is 0<b≦75.

7. A perpendicular magnetic recording medium according to claim 5, wherein Y is Ru.

8. A perpendicular magnetic recording medium according to claim 1, wherein the thickness of the intermediate layer is in the range from 1 nm to 20 nm.

9. A method of manufacturing a perpendicular magnetic recording medium comprising the steps of sequentially laminating an under-layer, an intermediate layer, a recording layer, a protective layer, and a liquid lubricant layer on a substrate, wherein the intermediate layer has an amorphous structure, and the recording layer formed on the intermediate layer has a fine grain size and a uniform grain size distribution by providing the intermediate layer with the amorphous structure.

10. A method of manufacturing a perpendicular magnetic recording medium according to claim 9, wherein the intermediate layer has a composition of Ti₁₀₀₋ₐXₐ, where X is Cr or Ru and a is 0≦a<100 in atomic percent.

11. A method of manufacturing a perpendicular magnetic recording medium according to claim 10, wherein a is 0<a≦50.

12. A method of manufacturing a perpendicular magnetic recording medium according to claim 10, wherein X is Cr.

13. A method of manufacturing a perpendicular magnetic recording medium according to claim 9, wherein the intermediate layer has a composition of Zr_{100-b}Y_{b}, where Y is Cr or Ru and b is 0≦b<100 in atomic percent.

14. A method of manufacturing a perpendicular magnetic recording medium according to claim 13, wherein b is 0<b≦75.

15. A method of manufacturing a perpendicular magnetic recording medium according to claim 13, wherein Y is Ru.

16. A method of manufacturing a perpendicular magnetic recording medium according to claim 9, wherein the thickness of the intermediate layer is in the range from 1 nm to 20 nm.
